(19) United States
(12) Patent Application Publication
(10) Pub. No.: US 2016/0041960 A1
(43) Pub. Date: Feb. 11, 2016

(54) METHOD AND DEVICE FOR CONTROLLING THE SAME

(71) Applicant: Samsung Electronics Co., Ltd., Gyeonggi-do (KR)

(72) Inventor: Chae-hoon LIM, Seoul (KR)

(21) Appl. No.: 14/817,439

(22) Filed: Aug. 4, 2015

(30) Foreign Application Priority Data
Aug. 8, 2014 (KR) 10-2014-0102622

(51) Int. Cl. G06F 17/24; G06F 3/0354; G06F 3/0481; G06F 3/0486; G06F 3/0484; H04L 29/08

(52) U.S. Cl. CPC G06F 17/241; G06F 3/04842; H04L 67/10; G06F 3/04817; G06F 3/0486; G06F 3/03545; G06F 17/24

(57) ABSTRACT

An electronic device and method for executing a memo function is disclosed. The electronic device includes an input unit and a display, and a control unit operable to execute the method, including generating a memo including user information received from a user input, detecting selection of at least one application to be associated with the generated memo, in response to the detected selection, displaying an image at least partially overlaying or adjacent to an icon representing the selected at least one application, and when the selected at least one application is executed, displaying the memo in an execution screen of the at least one application.

### CLAIM OF PRIORITY

This application claims the benefit of Korean Patent Application No. 10-2014-0102622, filed on Aug. 8, 2014, in the Korean Intellectual Property Office, the disclosure of which is incorporated herein in its entirety by reference.

### TECHNICAL FIELD

One or more example embodiments relate to a method and device for controlling a device in association with execution of an application.

### BACKGROUND

With advancement in multimedia technology and data processing technology, devices have been developed to simultaneously execute a plurality of applications and process various information.

Some of these devices may include a memo function and/or an application including a memory function. For such applications, a specific message may be input to an application such as, for example, a memo. The memo may be stored, and then the application may be ended. Thus, in order to view a previously stored memo, a user must execute the application to facilitate display of the memo. However, because the user would prefer to view the memo on a particular position on the display and at a particular point of time, the utilization rate of these memo functions for existing devices is low.

### SUMMARY

One or more example embodiments include a device capable of displaying a memo previously set by a user in a screen for executing an application selected by the user, and a method of controlling the same.

One or more example embodiments also include a non-transitory computer-readable recording medium storing a program for executing the method in a computer.

Additional aspects will be set forth in part in the detailed description which follows and, in part, will be apparent from the description, or may be learned by practice of the presented example embodiments.

According to one or more example embodiments, a method of controlling a device includes generating a memo including user information received from a user input, detecting selection of at least one application to be associated with the generated memo, in response to the detected selection, displaying an image at least partially overlaying or adjacent to an icon representing the selected at least one application, and when the selected at least one application is executed, displaying the memo in an execution screen of the at least one application.

The memo may be generated in an execution screen of another executing application, based on the user input.

The method may further include detecting selection of a plurality of applications to be associated with the generated memo, in response to detecting the selection of the plurality of applications, displaying the image at least partially overlaying or adjacent to icons representing the selected plurality of applications, and when one of the selected plurality of application is executed, displaying the generated memo in an execution screen of the executed one of the selected plurality of applications.

The method may further include detecting selection of content included in an application to be associated with the generated memo, displaying the image corresponding to the generated memo at least partially overlaying or adjacent to a content execution object selectable to display the selected content, and when the selected content is displayed, displaying the generated memo in an execution screen of the application reproducing the selected content. The method may further include detecting editing the user information of the generated memo displayed in the execution screen of the at least one application, based on the user input; and displaying the edited user information of the generated memo in the execution screen of the at least one application.

The detected selection may further comprise a drag input signal continuously moving from a first position to a second position on a touch panel of the device.

The user input may be input using a stylus pen by which data is input to a touch panel of the device.

The memo may be displayed in the execution screen for the at least one application, and may be stored in an application with a memo function configured to display the generated memo.

According to one or more example embodiments, an electronic device may include a display unit, an input unit, and a control unit, configured to: generate a memo including user information received from a user input detected via the input unit, detect selection of at least one application be associated with the generated memo, in response to detecting the selection, controlling the display unit to display an image at least partially overlaying or adjacent to an icon representing the selected at least one application, and when the selected at least one application is executed, displaying the memo in an execution screen of the at least one application.

According to one or more example embodiments, a non-transitory computer-readable recording medium of an electronic device is disclosed, having recorded thereon a program, executable by a processor of the electronic device to: generate a memo including user information received from a user input, detect selection of at least one application to be associated with the generated memo, in response to the detected selection, display an image at least partially overlaying or adjacent to an icon representing the selected at least one application; and when the selected at least one application is executed, display the memo in an execution screen of the at least one application.

### BRIEF DESCRIPTION OF THE DRAWINGS

These and/or other aspects will become apparent and more readily appreciated from the following description of the example embodiments, taken in conjunction with the accompanying drawings in which:

FIG. 1 is a block diagram of a device according to an example embodiment of the present disclosure;

FIG. 2 is a flowchart of a method of controlling a device according to an example embodiment of the present disclosure;

FIG. 3 is a diagram illustrating an example of the method of FIG. 2 according to an example embodiment of the present disclosure;

FIG. 4 is a flowchart of a method of selecting an application to be displayed with a memo, which is included in a method of controlling a device, according to an example embodiment of the present disclosure;

FIG. 5 is a diagram illustrating an example of the method of FIG. 4 according to an example embodiment of the present disclosure;

FIG. 6 is a flowchart of a method of displaying a memo when an application is executed, which is included in a method of controlling a device, according to an example embodiment of the present disclosure;

FIG. 7 is a diagram illustrating an example of the method of FIG. 6 according to an example embodiment of the present disclosure;

FIG. 8 is a flowchart of a method of controlling a device according to another example embodiment of the present disclosure;

FIG. 9 is a diagram illustrating an example of the method of FIG. 8 according to an example embodiment of the present disclosure;

FIG. 10 is a diagram illustrating a method of controlling a device according to another example embodiment of the present disclosure;

FIG. 11 is a diagram illustrating an application with a memo function according to an example embodiment of the present disclosure; and

FIG. 12 is a block diagram of a device according to another example embodiment of the present disclosure.

### DETAILED DESCRIPTION

Reference will now be made in detail to example embodiments, examples of which are illustrated in the accompanying drawings, where like reference numerals refer to like elements throughout. In this regard, the present example embodiments may have different forms and should not be construed as being limited to the descriptions set forth herein. Accordingly, the example embodiments are merely described below, by referring to the figures, to explain aspects of the present description.

First, the terms used in the present disclosure will be briefly described before example embodiments will be described in detail.

In the present disclosure, general terms that have been widely used nowadays are selected, if possible, in consideration of functions of the inventive concept, but non-general terms may be selected according to the intentions of technicians in the this art, precedents, or new technologies, etc. Also, some terms may be arbitrarily chosen by the present applicant. In this case, the meanings of these terms will be explained in corresponding parts of the present disclosure in detail. Thus, the terms used herein should be defined not based on the names thereof but based on the meanings thereof and the whole context of the inventive concept.

As used herein, it will be understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Also, the terms “unit', module” and the like should be understood as units for performing at least one function or operation, and may be embodied in a hardware manner, a software manner, or a combination thereof

In the present disclosure, it will be understood that when an element or layer is referred to as being “connected to” another element or layer, the element or layer can be directly connected to another element or layer or can be electrically connected to another element or layer via elements or layers interposed therebetween. As used herein, the term “and/or” includes any and all combinations of one or more of the associated listed items). Expressions such as “at least one of,” when preceding a list of elements, modify the entire list of elements and do not modify the individual elements of the list.

In the present disclosure, the term “application” should be understood as a set of computer programs designed to perform a special operation. Various types of applications may be described in the present disclosure. For example, examples of an application may include, but are not limited to, a web browser, a camera application, a dictionary application, a translation application, a data transmission application, a music reproduction application, a video reproduction application, a message application, a social communicator application, a social media application, a map application, a photo folder application, a broadcast application, a game application, an exercise support application, a payment application, a memo application, a calendar application, a phone book application, etc.

In the present disclosure, the term “content” should be understood as digital information provided via a wire/wired communication network. According to an example embodiment, examples of a content may include, but are not limited to, a video content (e.g., a TV program video, a video on demand (VOD), user-created contents (UCC), a music video, a YouTube video, etc.), a still image content (e.g., a photograph, a picture, etc.), a text content (e.g., an electronic book (a poet, a novel, etc.), a letter, a business file, etc.), a music content (e.g., music, a musical program, a radio broadcast, etc.), a web page, application execution information, etc.

Hereinafter, example embodiments will be described in detail with reference to the accompanying drawings so that those of ordinary skill in the art can easily accomplish the inventive concept.

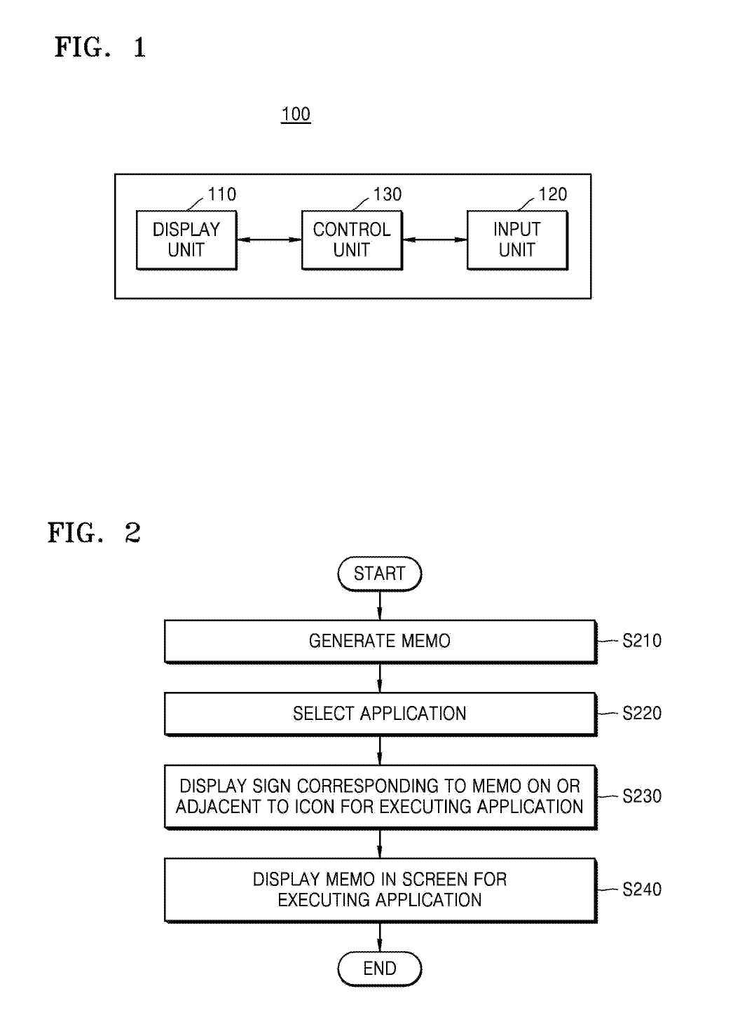

FIG. 1 is a block diagram of a device 100 according to an example embodiment.

According to an example embodiment, the device 100 may include a display unit 110, an input unit 120, and a control unit 130 for controlling the display unit 110 and the input unit 120. Only components of the device 100 related to the present embodiment are illustrated in FIG. 1. However, it will be apparent to those of ordinary skill in the art that other general components may be further included in the device 100.

The display unit 110 may display and output information processed by the device 100. According to an example embodiment, the display unit 110 may display an icon and screen for executing an application, a memo, and a sign corresponding to the memo.

The input unit 120 may be a means by which user inputs to the device 100 (e.g., data, a control signal, etc.) may be received. Examples of the input unit 120 may include, but are not limited to, a key pad, a dome switch, a touch pad (such as one employing a contact type electrostatic capacitance method, a pressure type resistive film method, an infrared sensing method, a surface acoustic wave conduction method, an integral type tension measurement method, a piezo effect method, etc.), a jog wheel, or a jog switch, etc.

According to an example embodiment, the device 100 may receive a user input generating a memo on a screen of the device 100 and a signal for selecting at least one application to be marked with a sign corresponding to the memo, via the input unit 120. Also, user input editing a memo displayed in a screen for executing an application may be received via the input unit 120.

According to an example embodiment, a signal for selecting a content included in an application in which a memo is to be displayed on the screen of the device 100 may be received via the input unit 120.

The control unit 130 controls overall operations of the device 100, and controls the input unit 120 and the display unit 110. The control unit 130 may facilitate the operations of marking a sign corresponding to a memo on or adjacent to an icon for executing at least one application, and displaying a memo in a screen for executing at least one application, as will be described further below.

Also, the control unit 130 may control the device 100 to mark a sign corresponding to a memo on or adjacent to a content execution object reproducing selected content, and display the memo in a screen reproducing the content, as will be described further below.

In one example embodiment of the present disclosure, the device 100 may be implemented in various ways. Examples of the device 100 described in the present disclosure may include, but are not limited to, a mobile phone, a smartphone, a laptop computer, a tablet personal computer (PC), an electronic book terminal, a digital broadcast terminal, a personal digital assistant (PDA), a portable multimedia player (PMP), a navigation device, a smart TV, a consumer electronics (CE) device (e.g., a refrigerator with a display panel, an air conditioner with a display panel, etc.), etc.

FIG. 2 is a flowchart of a method of controlling the device 100 of FIG. 2 according to an example embodiment.

In operation S210, the device 100 may generate a memo based on user input. According to an example embodiment, the memo may be generated using a memo function provided by, for example, an operating system (OS) of the device 100. Also, according to another example embodiment, the memo may be generated using an installed application that includes a memo function. According to an example embodiment, a user may input an information into a memo using the input unit 120 of the device 100. The input information (e.g., a desired message) may be input using, for example, a stylus pen, by which data may be input to a touch panel (not shown) included in the device 100, or by touch input to the touch panel by a user. Thus, the device 100 may generate a memo including the user's input information. According to an example embodiment, the generated memo may be stored in a storage medium included in the device 100, or may be separately stored in a storage space allocated to the application having the memo function.

In operation S220, the device 100 may select at least one application for displaying the memo. That is, the device 100 may select at least one application for displaying the memo generated in operation S210. According to an example embodiment, the at least one application may be selected according to a user's selection signal. The user's selection signal may be, for example, a touch input performed on the device 100. Selecting the application to display the memo may be executed because the memo is displayed when the selected application is executed. Also, selecting the application to display the memo may be facilitated by display of marking of a sign, symbol or icon corresponding to the memo on an icon representing the application to be selected. According to an example embodiment, the sign corresponding to the memo may be, for example, an image indicating the presence or relevance of the memo, or an image of the memo that is reduced in size.

In operation S230, the device 100 may display the sign corresponding to the memo on or adjacent to the icon for executing the application. That is, the device 100 may mark the icon representing the application with the sign corresponding to the memo generated in operation S210 by displaying the sign on or adjacent to the in operation S220. According to an example embodiment, the icon for executing the application may be an image displayed on the screen of the device 100 which is an object selectable to cause execution of the application. According to an example embodiment, the sign corresponding to the memo may smaller than the icon for executing the application, or the sign may be an image of the memo and reduced in size. Additionally, the marking the icon with the sign including displaying the sign as partially overlapping the icon, as displayed on the screen of the device 100. According to an example embodiment, the sign may at least partially overlap the icon for executing the application.

In operation S240, the device 100 may display the memo in a screen executing the application. According to an example embodiment, a user may select an icon for executing an application marked with the sign, and the application may be executed according to the user's selection. In this case, the memo corresponding to the sign may be also displayed in the screen executing the application. In detail, the device 100 may mark the icon representing the application with the sign (as generated in operation S210) in operation S220. When the device 100 executes the application selected in operation S220 in response to a user input such as a user's touch input, the device 100 may also display the memo generated in operation S210 in the screen executing the application. According to an example embodiment, an application with a memo function is executed to display a previously stored memo simultaneously with executing and displaying the specific application. According to an example embodiment, the memo may be continuously displayed on the screen of the device 100 while the application is executing, or may disappear from the screen of the device 100 after a predetermined time has lapsed. Also, the position and size of the memo displayed while the application is executing may be set by a user. Also, according to an example embodiment, a font size, color and transparency of the memo displayed while the application is executing may be changed according to a user's setting.

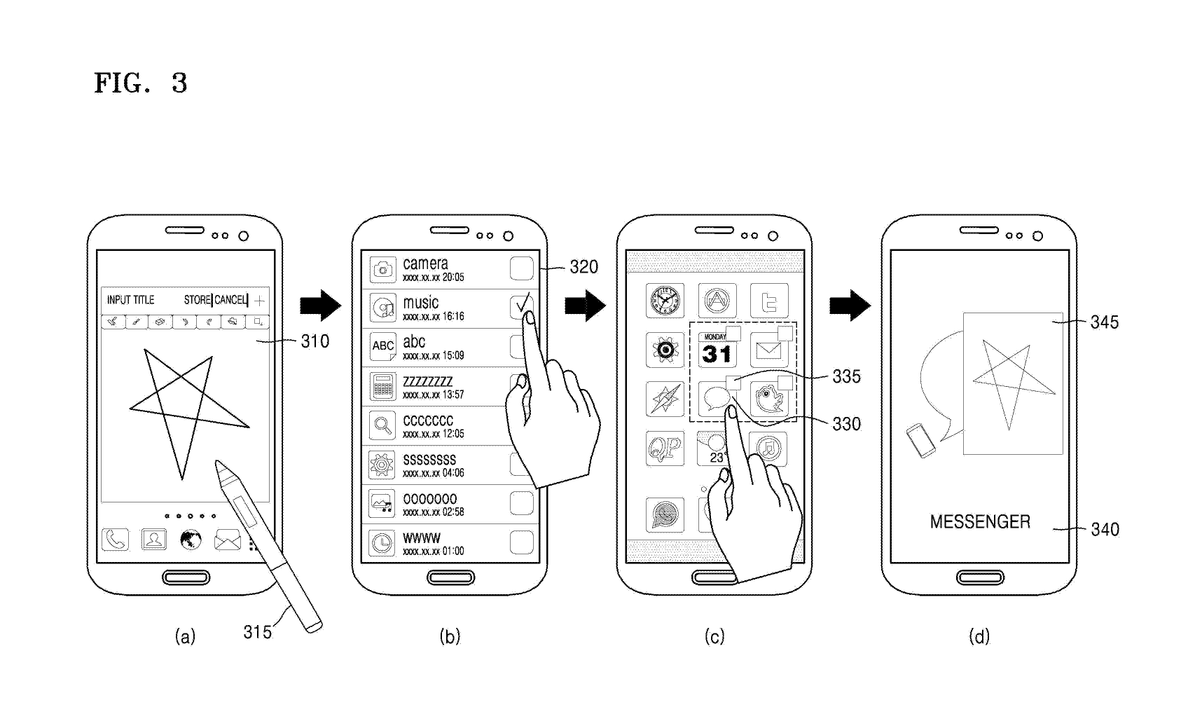

FIG. 3 is a diagram illustrating an example of the method of FIG. 2 according to an example embodiment.

FIG. 3(a) illustrates an example of operation S210 of FIG. 2 according to an example embodiment. A user may request by a memo calling signal a region 310 for generating a memo on the screen of the device 100 of FIG. 1, the memo function implemented within an OS or a memo application. The user may input the memo calling signal to generate the region 310 for generating a memo. For example, the user may input a fast double-tap input signal (e.g., two taps without a pause) using, for example, a stylus pen by which data may be input to the screen of the device 100, so as to generate the region 310 for inputting memo information within a memo application. Also, the user may generate the region 310 on the screen of the device 100 by inputting a voice signal, such as a spoken keyword (e.g., “memo”). According to an example embodiment, the user may input a desired message to the region 310 using a stylus pen 315.

FIG. 3(b) illustrates an example of operation S220 of FIG. 2 according to an example embodiment of the present disclosure. A user may select an application to be marked with a sign corresponding to the memo generated in FIG. 3(a), and/or to be displayed with the memo. According to an example embodiment, the user may select an application from among a list of applications 320 installed in the device 100. According to an example embodiment, the list of applications 320 may be set beforehand by the user, and the user may exclude one or more applications from the list of applications 320 among the totality of applications installed in the device 100.

FIG. 3(c) illustrates an example of operation S230 of FIG. 2 according to an example embodiment of the present disclosure. According to an example embodiment, an image of an icon 330 for executing the application selected in FIG. 3(b) may partially overlap with an image of a sign 335 corresponding to the memo. Although the sign 335 is illustrated as a square shape in FIG. 3(c), the shape, size, or position of the sign 335 displayed on or adjacent to the icon 330 may differ from that illustrated in FIG. 3(c).

FIG. 3(d) illustrates an example of operation S240 of FIG. 2 according to an example embodiment of the present disclosure. When an application marked with a sign is executed according to a user's selection, a memo 345 corresponding to the sign may be displayed in a screen 340 for executing the application. The size or position of the memo 345 displayed in the screen 340 may be determined beforehand by the user, and is not limited by the size or position as illustrated in FIG. 3(d).

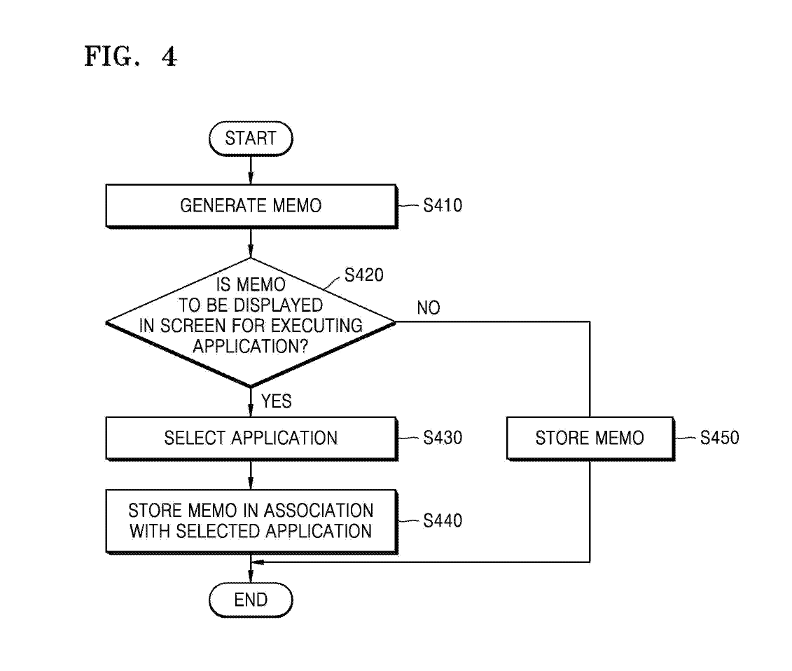

FIG. 4 is a flowchart of a method of selecting an application to be displayed with a memo, which is included in a method of controlling the device 100 of FIG. 1, according to an example embodiment of the present disclosure.

In operation S410, the device 100 may generate a memo by receiving information from a user to be stored within the memo. That is, the user may execute a memo function (either through an OS or an application with a memo function) on a screen of the device 100. Also, according to an example embodiment, the user may execute either the memo function even while another application is being executed. That is, the user may activate a memo function of the device 100 by inputting a specific input signal while the application is executing, and input information into the memo function to generate the memo, which may be disposed in a region of the screen designated for the memo when the memo function is activated.

In operation S420, the device 100 may detect whether the memo generated by the user is to be displayed in an execution screen of an application.

According to an example embodiment, in operation S430, when, the device 100 determines that the memo is to be displayed in the execution screen of the application based on user input, the user may select at least one application for which the generated memo will be displayed upon execution. According to an example embodiment, the user may select at least one such application from among a list of applications as illustrated in FIG. 3(b). According to another example embodiment, the user may select the at least one application by dragging an object representing the memo and dropping the object on an icon representing the desired application. The drag and drop input may be understood as a user operation involving dragging and dropping of an object to a predetermined position on the screen of the device 100, using a finger or a touch input tool, such as a stylus. Further, dragging may be understood as continuously moving a touch input from a first position to a second position on a touch panel of the device 100.

According to an example embodiment, in operation S440, the device 100 may store the memo in association with the application selected in operation S430. The memo may be stored in a storage region corresponding or related to the memo within a storage medium included in the device 100. According to an example embodiment, the stored memo may be displayed in an execution screen of the selected application when the selected application is later executed.

In operation S450, when in operation S420, the device 100 determines that the memo is not to be displayed in the execution screen of the application based on the user input, the device 100 may store the memo in either a storage region related to the memo of a storage medium included in the device 100, or a storage region related to an application with a memo function, per to the user's selection.

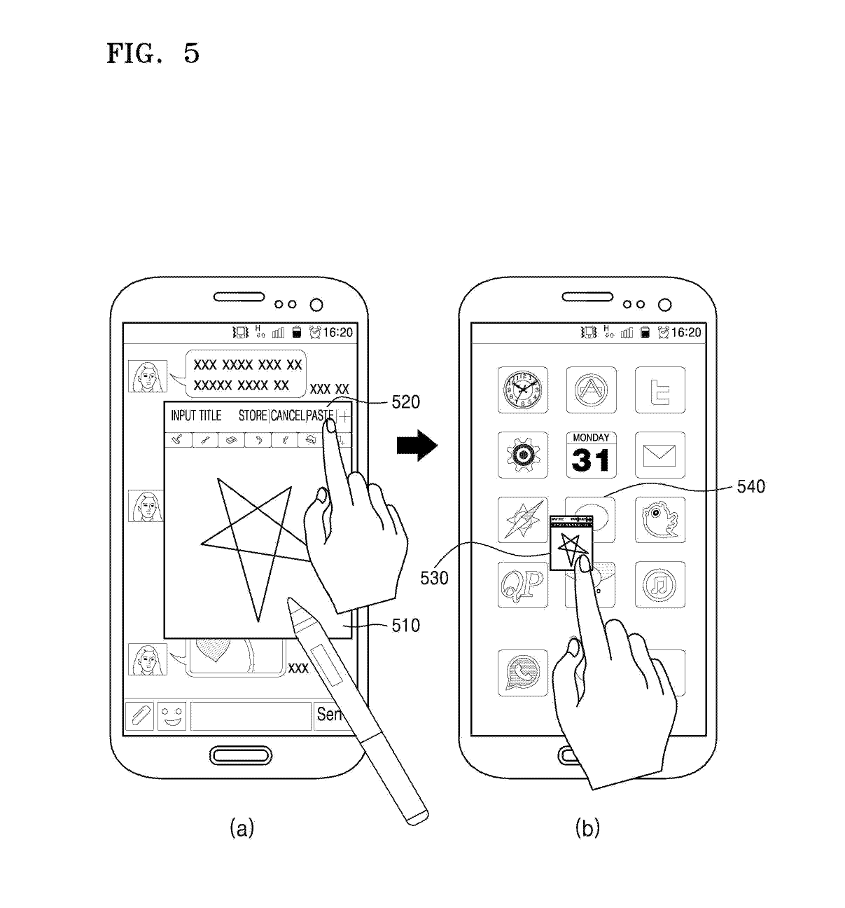

FIG. 5 is a diagram illustrating an example of the method of FIG. 4 according to an example embodiment.

According to an example embodiment, a user may request display of a memo in a region 510 for displaying a memo while an application is executed, as illustrated in FIG. 5(a) (although it is noted the user may also display a memo in a home screen of the device 100 of FIG. 1, as illustrated in FIG. 2(a)). According to an example embodiment of the present disclosure, the home screen of the device 100 may be a default screen displayed when the device 100 is initially powered on. Alternatively, the home screen of the device 100 may be a screen displaying various icons representing applications installed in the device 100.

According to an example embodiment, a user may input memo information into the region 510 for generating a memo, and then touch select a ‘paste’ menu option 520. The ‘paste’ menu option 520 facilitates selection of an application to be displayed with the memo. It is understood the present disclosure is not meant to be limiting, and that “paste” may be used interchangeably with another term as desired. According to an example embodiment, the user may then select an application from among a list of applications (as illustrated in FIG. 3B) upon activation of the ‘paste’ menu option 520. According to another example embodiment, the user may touch the ‘paste’ menu option 520, and select an application to be displayed with the memo according to a drag and drop signal, (i.e., through an operation of dragging a memo 530). That is, the user may drag a reduced size image representing the generated memo, and after activating the ‘paste’ menu option 520 by, for example, touch input, drop the reduced size image onto an application execution icon 540, as seen in FIG. 5(b).

After the user generates the memo, the device 100 may set the application corresponding to the application execution icon 540 as the selected application, such as that the device 100 may display the memo generated by the user when the selected application is later executed.

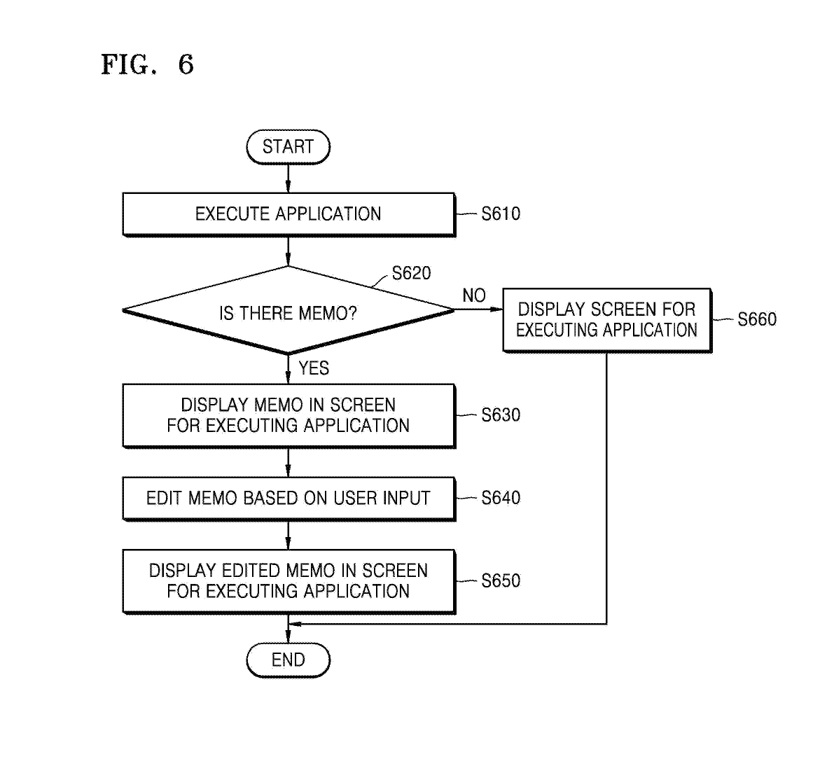

FIG. 6 is a flowchart illustrating an example method for displaying a memo when the selected application is executed via operation and control of the device 100 of FIG. 1, according to an example embodiment of the present disclosure.

In operation S610, the device 100 executes the selected application according to a user's selection signal.

In operation S620, the device 100 may detect whether there is a memo to be displayed with the selected application. That is, the device 100 may determine whether a memo is stored in association with the selected application to be executed. For example, the device 100 may determine whether the application executed in operation S610 is identical to the selected application of operation S430 from FIG. 4.

In operation S660, when in operation S620, the device 100 determines that there is no memo stored in association with the executed application, the device 100 displays the execution screen of the application. That is, according to an example embodiment, when the user selects an icon for executing an application, lacking the sign indicating the presence of a corresponding memo, the device 100 displays an execution screen of the selected application without displaying any memo.

In operation S630, when in operation S620, the device 100 determines that there is a memo stored in association with the application, the device 100 may display the memo in an execution screen of the application. That is, according to an example embodiment, when the user selects an to execute an application, and the application includes an adjacent or overlaying sign indicating the presence of a corresponding memo, the device 100 may display the memo corresponding to the sign when displaying the execution screen of the application corresponding to the selected icon.

In operation S640, the device 100 may edit the memo displayed with the application, based on user input. Also, the device 100 may store the edited memo.

According to an example embodiment, the user may change or delete the memo displayed with the application. Also, the user may select another application to be displayed with the memo so that the memo may be displayed with an application other than the application that is being currently executed.

In operation S650, the device 100 may display the memo edited by the user in the screen for executing an application.

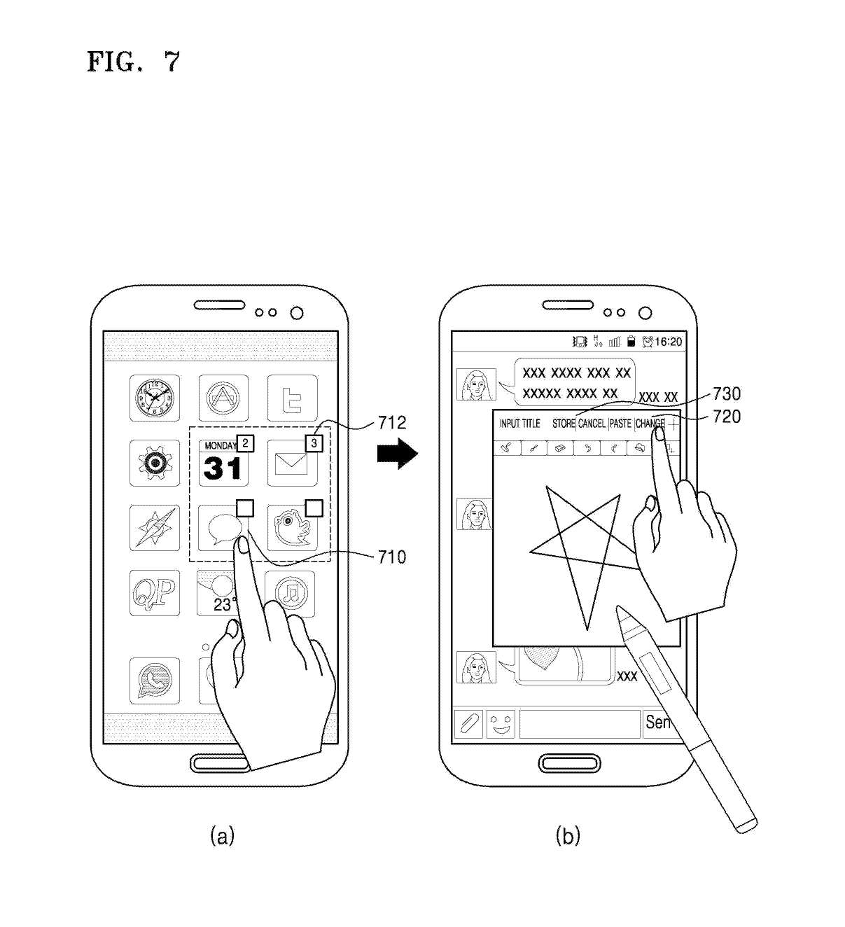

FIG. 7 is a diagram illustrating an example of the method of FIG. 6 according to an example embodiment of the present disclosure.

Referring to FIG. 7(a), the device 100 (of FIG. 1) detects selection of an application 710 marked with a sign 712 according to a user's selection signal. According to an example embodiment, as illustrated in FIG. 7(a), the number of memos stored in association with an application may be marked on the sign 712 denoting a memo. For example, ‘3’ marked on the sign 712 should be understood that three memos may be displayed when the application is executed.

FIG. 7(b) illustrates an execution screen of the application 710 selected in FIG. 7(a). A user may touch a ‘change’ menu 720 of a memo displayed with the executing application 710. After detecting a touch input to the ‘change’ menu 720, the display may change information content of the displayed memo, and after detecting a touch input to the ‘store’ menu 730, the changed content information in the memo may be stored. Also, when the detecting selection of another application other than the presently displayed application including the memo, such as, for example, detecting selection of another application through the ‘paste’ menu option, the device 100 may redisplay the memo when the other application is executed.

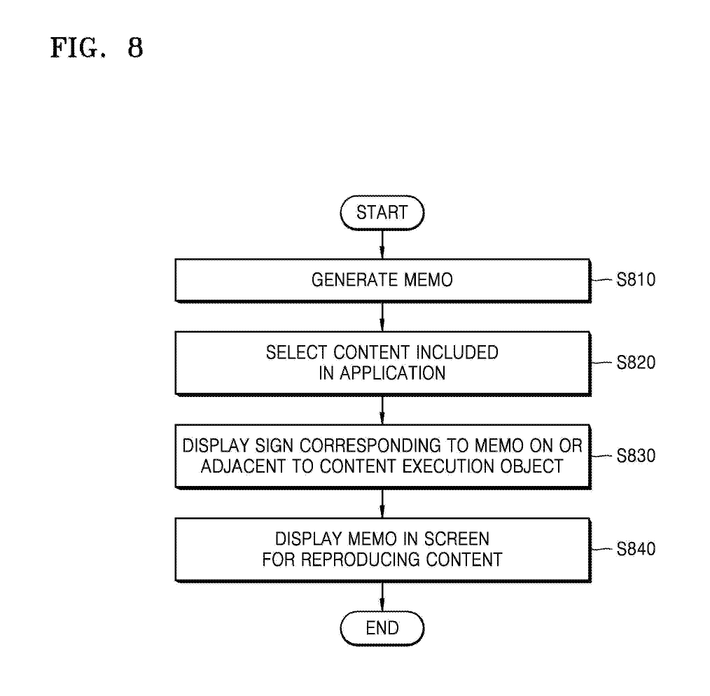

FIG. 8 is a flowchart of a method of controlling the device 100 of FIG. 1 according to another example embodiment of the present disclosure,

In operation S810, the device 100 may generate a memo including input information, based on user input. Operation S810 is substantially the same as operation S210 of FIG. 2 and operation S410 of FIG. 4 and will not be thus described here again for the sake of brevity.

In operation S820, the device 100 may detect selection of content included in an application, the content previously indicated to include the memo when displayed in response to the user input. That is, the device 100 may detect selection of application content for which the memo may be displayed in tandem in operation S810.

In operation S830, the device 100 may display a sign indicating presence of the associated the memo at least partially overlaying or adjacent to a content execution object representing the content selected to be displayed with the memo. That is, the device 100 may mark the object for executing the content with the sign in operation S820. According to an example embodiment, the content execution object may be an object selectable to execute the content when the object, such as, for example, an icon or image displayed on the screen of the device 100. For example, when the selectable content is a music content, a playlist or a portion thereof may be the object for executing the music content. When the content is photographic imagery, thumbnail images (e.g., reduced size versions of the photographs may be the object selectable to execute (or display) the photographic content.

In operation S840, the device 100 may display the memo in an execution screen displaying the content. According to an example embodiment, the user may select the object to execute display of the content (previously marked with the sign to indicate the association with the memo), and the content may be reproduced and displayed in response to the user selection. In this case, the associated memo corresponding to the sign may then be displayed in the execution screen displaying the content. In detail, the object for executing the content may have been marked, according to the user's selection in operation S820. When the device 100 reproduces and/or displays the content selected in operation S820 according to user input (e.g., the user's touch), the device 100 may display the generated memo in the execution screen displaying the content. According to an example embodiment, displaying of a memo in a screen for reproducing a content may be understood that an application with a memo function is executed to display a previously stored memo simultaneously with the executing of the content. According to an example embodiment, the memo may be continuously displayed on the screen of the device 100 while the application is executed or may disappear from the screen of the device 100 after a predetermined time.

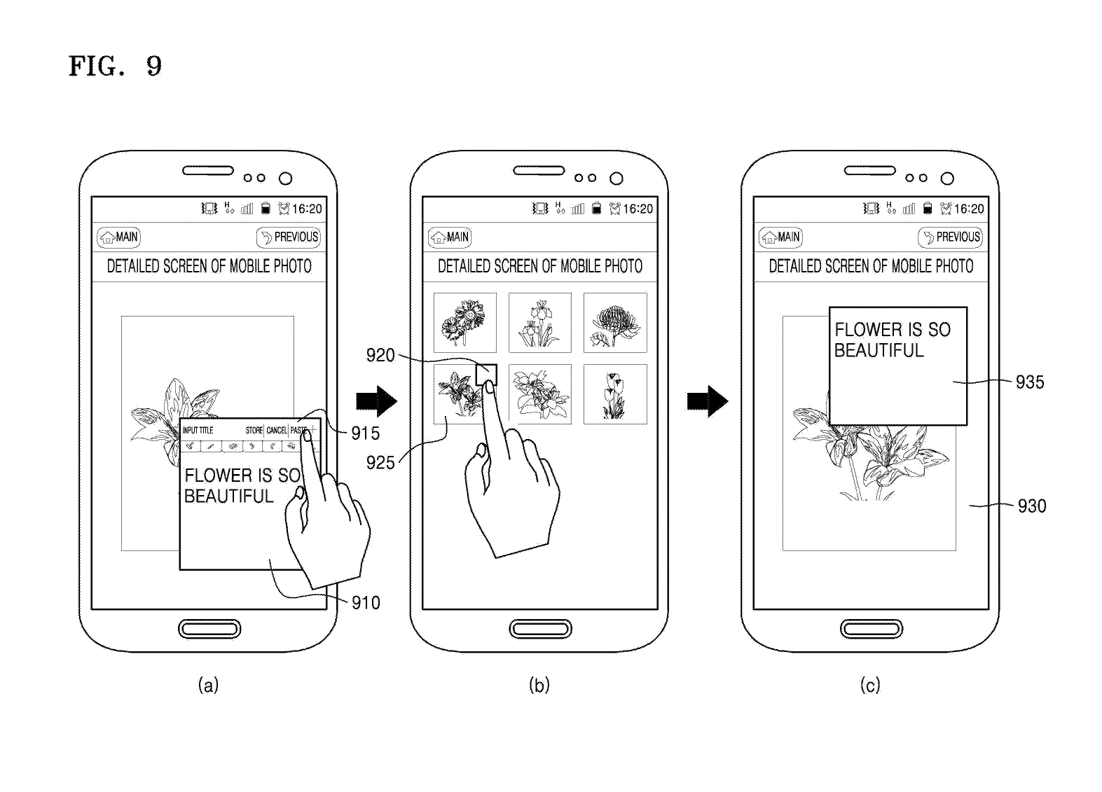

FIG. 9 is a diagram illustrating an example of the method of FIG. 8 according to an example embodiment.

FIG. 9(a) illustrates an example of operation S810 of FIG. 8 according to an example embodiment of the present disclosure. A user may request display of a region 910 for generating a memo according to, for example, an OS or a memo application, while some application content is reproduced and displayed. Although finger-based touch inputs are displayed herein, the user may also input a desired message to the region 910 for inputting information into the memo using, for example, a digital stylus pen.

FIG. 9(b) illustrates examples of operations S820 and S830 of FIG. 8 according to an example embodiment of the present disclosure. A user may select a content to be marked with a sign corresponding to a memo generated in FIG. 9(a). According to an example embodiment, the user may touch and select a ‘paste’ menu option 915 of the memo displayed in FIG. 9(a) and then the device 100 may display the screen as shown in FIG. 9(b). Here, the user may select an execution object 925 to be associated with the memo generated in FIG. 9(a) from among a number of execution objects, which, in this example, are thumbnail images or reduced size images representing a number of photographs. The selected execution object 925 may be marked with a sign 920 to indicate association with the memo. According to an example embodiment, selection of the execution object 925 may be indicated by detecting a touch input selecting a thumbnail of the list of thumbnail images, or detecting a touch input dragging an object representing the memo and dropping of the object over the execution object 925.

FIG. 9(c) illustrates an example of operation S840 of FIG. 8 according to an example embodiment of the present invention. When a particular piece of content, previously marked with a sign indicating association with a menu, is executed according to a user's selection, a memo 935 corresponding to the sign may be displayed in an execution screen 930 for the content. The size or position of the memo 935 displayed with the screen 930 may be preset by the user and is not limited by the size or position of the memo 935, as illustrated in FIG. 9(c). Also, a font size, color, or transparency of the memo 935 may be changed according to the user's setting.

The embodiments of FIG. 9(a) to (c) are applicable to various reproducible content, including not only photo contents, but also music contents, video contents, and any other acceptable form of media or information content, etc.

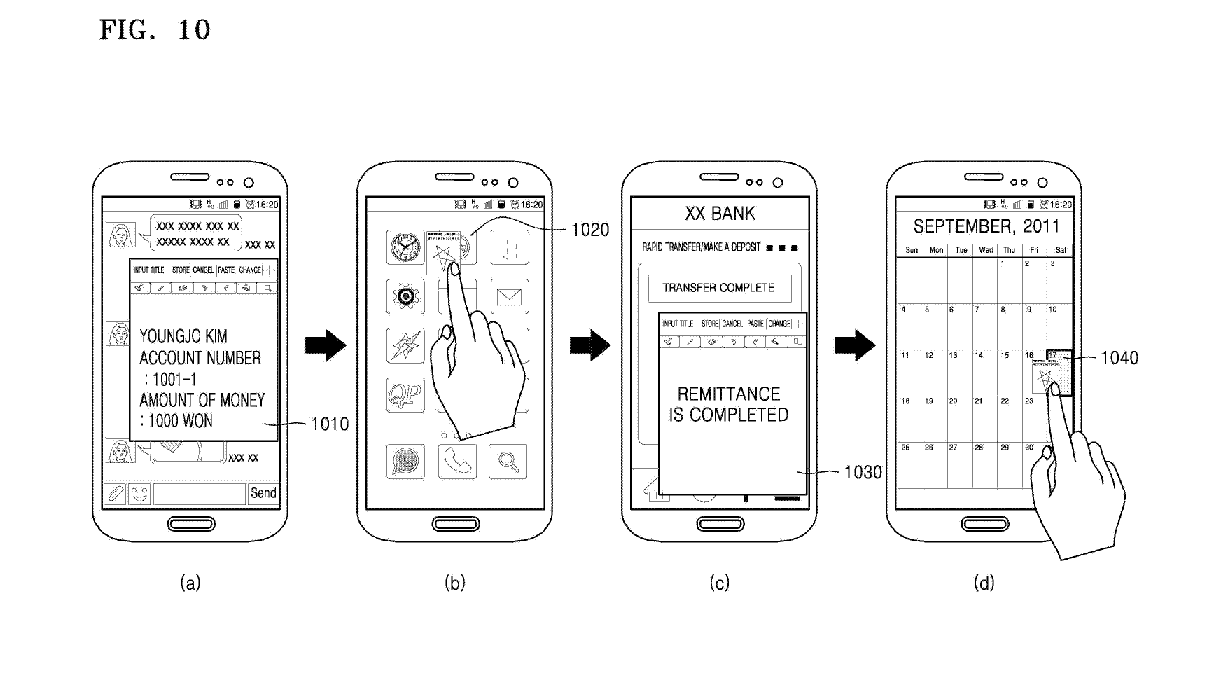

FIG. 10 is a diagram illustrating a method of controlling the device 100 of FIG. 1 according to another example embodiment of the present disclosure.

Referring to FIG. 10(a), a user may receive a request to remit money from his/her friend while chatting with his/her friend. In this case, a region 1010 for generating a memo may be provided to the user from the device 1000 in response to detection of a memo calling signal (e.g., generated by the user), and the user may input to the memo the requested amount of money or an account number in the region 1010. When the user completes generation of the memo by the input of all necessary information, the user select a ‘paste’ menu option of the region 1010 (as described previously).

Referring to FIG. 10(b), the user may select an application to be displayed in association with the memo generated in FIG. 10(a). According to an example embodiment, the user may select a ‘bank’ application 1020 among applications according to, for example, a drop and drop input operation (as described previously).

Referring to FIG. 10(c), when the user executes the ‘bank’ application 1020, the device 100 may display the generated memo 1030 (having been associated with the application 1020), including the account number or the amount of money, and displayed within an execution screen for executing the application 1020. In this case, the user may retrieve the necessary information from the memo 1030 and then execute an account transfer to his/her friend utilizing the ‘bank’ application 1020. After the account transfer is completed, the user may select a ‘change’ menu option of the memo 1030. Then, the user may edit the memo 1030 to include information, such as a message reciting that “remittance is completed.” After editing the memo 1030, the user may touch and select a ‘paste’ menu option to transition the memo to yet another application.

Referring to FIG. 10(d), the user may associate the memo with content in a scheduler application, such as a particular date, as seen in FIG. 10(c). That is, the user may select an execution object 1040 denoting the 17^{th} of July to be associated with the edited memo. When the association is complete, the selected execution object 1040 may be marked with a sign indicating the presence of the edited memo. When the user selects the execution object 1040 for the display, the device 100 may display the edited memo in an execution screen of the scheduler application displaying the 17^{th} of July.

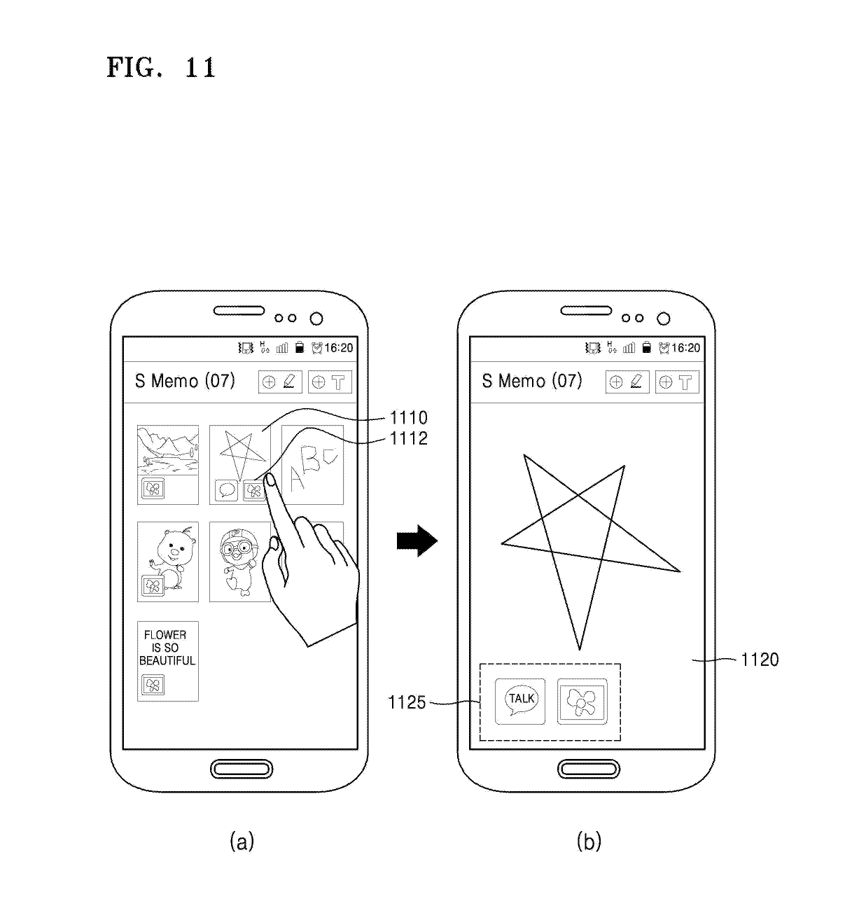

FIG. 11 is a diagram illustrating an application with a memo function according to an example embodiment.

According to an example embodiment, the device 100 of FIG. 1 may allow generation of a memo utilizing a memo function provided from an OS or an application with a memo function. It is assumed in the present embodiment that the memo is generated using an application with a memo function. The present embodiment is also applicable to a memo function provided from an OS.

FIG. 11(a) illustrates memos stored in an application including a memo function. The device 100 of FIG. 1 may store a generated memo (e.g., from operation S210 of FIG. 2 or operation 5410 of FIG. 4) in the application including the memo function. As illustrated in FIG. 11(a), a sign 1112 denoting an application to be displayed with each of memos may be displayed at least partially overlaying a thumbnail image of each of the memos. For example, signs denoting two applications may be displayed on a thumbnail image 1110 of an ‘A’ memo.

FIG. 11(b) illustrates an ‘A’ memo 1120 generated upon detecting selection of the thumbnail image 1110 of the ‘A’ memo of FIG. 11(a). According to an example embodiment of the present disclosure, a user may view the signs 1125 indicating applications displayable with the ‘A’ memo 1120, and change the ‘A’ memo 1120 by a selection thereof. Also, the device 100 may display the changed ‘A’ memo when an application associated therewith is executed. According to an example embodiment, when the user selects one of the signs 1125, an application corresponding to the selected sign may be executed and the ‘A’ memo may be displayed in an execution screen of the newly executed application.

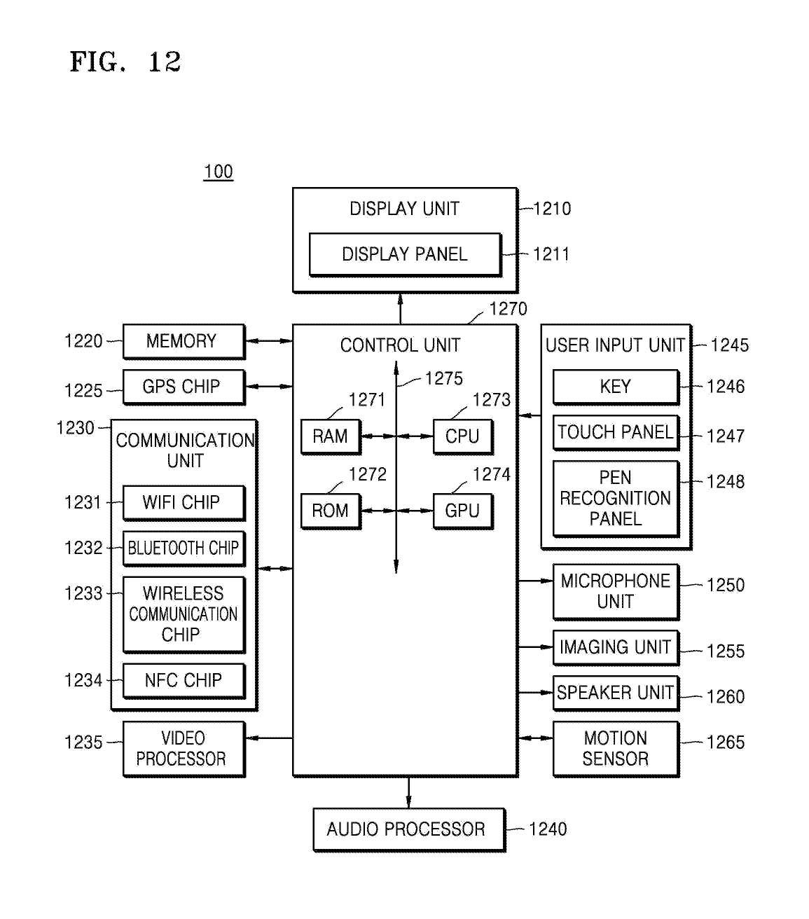

FIG. 12 is a block diagram of a device 100 according to another example embodiment. The device 100 may include a display unit 1210, a control unit 1270, a memory 1220, a global positioning system (GPS) chip 1225, a communication unit 1230, a video processor 1235, an audio processor 1240, a user input unit 1245, a microphone unit 1250, an imaging unit 1255, a speaker unit 1260, and a motion sensor 1265. The display unit 110 of FIG. 1 may correspond to the display unit 1210. The input unit 120 of FIG. 1 may correspond to the user input unit 1245. The control unit 130 of FIG. 1 may correspond to the control unit 1270.

The display unit 1210 may include a display panel 1211 and a controller (not shown) for controlling the display panel 1211. The display panel 1211 may be embodied as various display devices such as a liquid crystal display (LCD), an organic light-emitting diode (OLED) display, an active-matrix (AM)-OLED, a plasma display panel (PDP), etc. The display panel 1211 may be embodied to be flexible, transparent, or wearable. The display unit 1210 may be combined with a touch panel 1247 of the user input unit 1245 to form a touch screen (not shown). For example, the touch screen may include a module in which the display panel 1211 and the touch panel 1247 are integrally combined in a stacked structure.

Although not shown, the memory 1220 may include at least one of an internal memory or an external memory.

The internal memory may include, for example, at least one among a volatile memory (e.g., a dynamic random access memory (DRAM), a static RAM (SRAM), a synchronous DRAM (SDRAM, etc.), a nonvolatile memory (e.g., a one-time programmable read-only memory (OTPROM), a programmable ROM (PROM), an erasable and programmable ROM (EPROM), an electrically erasable and programmable ROM (EEPROM), a mask ROM, a flash ROM, etc.), a hard disc drive (HDD), and a solid-state drive (SSD). According to an example embodiment, the control unit 1270 may load a command or data (received from at least one among a nonvolatile memory and other components) to the volatile memory and process it. Also, the control unit 1270 may store data, which is received from other components or is generated, in the nonvolatile memory.

The external memory may include, for example, at least one among a compact flash (CF) memory, a secure digital (SD) memory, a micro-secure digital (SD) memory, a mini-SD memory, an extreme digital (xD) memory, and a memory stick.

The memory 1220 may store various programs and data for operating the device 100. For example, the memory 1220 may temporarily or semi-permanently store at least a portion of a content to be displayed on a lock screen.

The control unit 1270 may control the display unit 1210 to display a part of contents stored in the memory 1220. In other words, the control unit 1270 may display a part of the contents stored in the memory 1220 on the display unit 1210.

The control unit 1270 may include at least one among a RAM 1271, a ROM 1272, a central processing unit (CPU) 1273, a graphic processing unit (GPU) 1274, and a bus 1275. The RAM 1271, the ROM 1272, the CPU 1273, the GPU 1274, and the like may be connected via the bus 1275.

The CPU 1273 accesses the memory 1220 to boot the system using an OS stored in the memory 1220. The CPU 1273 performs various operations using various programs, contents, data, etc. stored in the memory 1220.

The ROM 1272 stores a set of commands for booting the system, etc. For example, when a turn-on command is input to the device 100 to supply power thereto, the CPU 1273 may copy the OS stored in the memory 1220 to the RAM 1271 according to a command stored in the ROM 1272, and execute the OS so as to boot the system. After the booting of the system is completed, the CPU 1273 copies various programs stored in the memory 1220 to the RAM 1271 and executes the programs copied to the RAM 1271 to perform various operations. When the device 100 is booted, the GPU 1274 displays a user interface (UI) screen in a region of the display unit 1210. In detail, the GPU 1274 may generate a screen displaying an electronic document including various objects such as contents, icons, menus, etc. The GPU 1274 calculates attribute values such as coordinates, a shape, a size, a color, etc. according to the layout of the screen. Also, the GPU 1274 may generate screens with various layouts including objects, based on the calculated attribute values. The screens generated by the GPU 1274 may be provided to the display unit 1210 and displayed on regions of the display unit 1210.

The GPS chip 1225 may receive a GPS signal from a GPS satellite and calculate a current position of the device 100. The control unit 1270 may calculate a position of a user by using the GPS chip 1225 when a navigation program is used or a current position of a user is desired.

The communication unit 1230 may communicate with various types of external devices according to various communication methods. The communication unit 1230 may include at least one among a Wi-Fi chip 1231, a Bluetooth chip 1232, a wireless communication chip 1233, and a near-field communication (NFC) chip 1234. The control unit 1270 may communicate with various types of external devices by using the communication unit 1230.

The Wi-Fi chip 1231 and the Bluetooth chip 1232 may establish communication according to a Wi-Fi method and a Bluetooth method, respectively. When the Wi-Fi chip 1231 or the Bluetooth chip 1232 is used, various information may be transmitted or received by transmitting or receiving various connection information such as service set identification (SSID) and a session key and establishing communication based on the various information. The wireless communication chip 1233 should be understood as a chip for establishing communication according to various communication standards such as IEEE, Zigbee, 3^{rd} (3G) generation, 3^{rd} generation partnership project (3GPP), and long-term evolution (LTE). The NFC chip 1234 should be understood as a chip operating according to a NFC method using 13.56 MHz among various RF-ID frequency bands such as135 kHz, 13.56 MHz, 433 MHz, 860 to 960 MHz, and 2.45 GHz.

The video processor 1235 may process video data included in a content received via the communication unit 1230 or a content stored in the memory 1220. The video processor 1235 may perform various image processing operations related to the video data such as decoding, scaling, noise filtering, frame rate conversion, and resolution conversion.

The audio processor 1240 may process audio data included in a content received via the communication unit 1230 or a content stored in the memory 1220. The audio processor 1240 may perform various processing operations related to the audio data such as decoding, amplification, and noise filtering.

When a program for reproducing a multimedia content is executed, the control unit 1270 may drive the video processor 1235 and the audio processor 1240 to reproduce the multimedia content. The speaker unit 1260 may output audio data generated by the audio processor 1240.

Various commands may be input from a user via the user input unit 1245. The user input unit 1245 may include at least one among a key 1246, a touch panel 1247, and a pen recognition panel 1248.

The key 1246 may include various types of keys, such as mechanical buttons, wheels, etc. formed on various regions (e.g., a front surface, a side surface, a rear surface, etc.) of the exterior of a main body of the device 100.

The touch panel 1247 may sense a touch input performed by a user and output a touch event value corresponding to the sensed touch input. When the touch panel 1247 is combined with the display panel 1211 to form a touch screen (not shown), the touch screen may be embodied as various types of touch sensors such as an electrostatic touch sensor, a pressure-sensitive touch sensor, a piezoelectric touch sensor, etc. The electrostatic touch sensor employs a method of sensing micro-electricity generated when a surface of the touch screen is touched by a user's body and calculating the coordinates of a touched point by using a dielectric coated on the surface of the touch screen. The pressure-sensitive touch sensor includes two upper and lower electrode plates embedded therein, and may sense electric current flowing when a user touches a screen of the touch sensor and the two upper and lower electrode plates thus contact each other at a touched position, and calculate the coordinates of the touched position. A touch event generated by the touch screen may be generally generated with a user's finger but may be generated using an object formed of a conductive material causing a change in an electrostatic capacitance.

The pen recognition panel 1248 may sense a proximity input or a touch input performed using a user's touch pen (e.g., a stylus pen, a digitizer pen, etc.), and output an event based on the sensed proximity input or touch input. The pen recognition panel 1248 may be embodied, for example, according to an electromagnetic radiation (EMR) method, and may sense a touch input or a proximity input based on a change in the intensity of an electromagnetic field generated when a pen approaches the pen recognition panel 1248 or the pen recognition panel 1248 is touched by the pen. In detail, although not shown, the pen recognition panel 1248 may include a grid-type electromagnetic induction coil sensor, and an electronic signal processor that sequentially provides an alternate-current signal having a predetermined frequency to loop coils of the electromagnetic induction coil sensor. When a pen including a resonance circuit therein approaches a loop coil of the pen recognition panel 1248, a magnetic field transmitted from the loop coil generates electric current in the resonance circuit, based on mutual electromagnetic induction. An induction magnetic field may be generated from a loop coil of the resonance circuit, based on the electric current, and the pen recognition panel 1248 may detect the induction magnetic field from the loop coil that is in a signal reception state, thereby sensing a position accessed or touched by the pen. The pen recognition panel 1248 may be provided to occupy a predetermined area of the bottom of the display panel 1211, e.g., an area covering a display region of the display panel 1211.

The microphone unit 1250 may receive a user's voice or other sound and convert it into audio data. The control unit 1270 may use the user's voice received via the microphone unit 1250 in a calling operation, or convert the user's voice into audio data and store the audio data in the memory 1220.

The imaging unit 1255 may capture a still image or video under control of a user. The imaging unit 1255 may include a plurality of cameras, e.g., a front camera and a rear camera.

When the imaging unit 1255 and the microphone unit 1250 are prepared, the control unit 1270 may perform a control operation according to a user's voice received via the microphone unit 1250 or the user's motion recognized by the imaging unit 1255. For example, the device 100 may operate in a motion-controlled mode or a voice-controlled mode. When the device 100 operates in the motion-controlled mode, the control unit 1270 may activate the imaging unit 1255 to photograph a user, trace a change in the user's motion, and perform a control operation corresponding to the change in the user's motion. When the device 100 operates in the voice-controlled mode, the control unit 1270 may operate in a voice recognition mode to analyze the user's voice input via the microphone unit 1250 and perform a control operation according to the analyzed user's voice.

The motion sensor 1265 may sense a motion of the body of the device 100. The device 100 may rotate or be inclined in various directions. In this case, the motion sensor 1265 may include at least one among various sensors such as a geomagnetic sensor and an acceleration sensor, and sense characteristics of the user's motion such as the direction, angle, inclination and the like of rotation.

Although not shown in FIG. 12, according to an example embodiment, a universal serial bus (USB) port to which a USB connector is connected, various external input ports to which various external terminals such as a headset, a mouse, a local area network (LAN), etc., are connected, a digital multimedia broadcasting (DMB) chip for receiving and processing a DMB signal, various sensors, etc. may be further included in the device 100.

The names of the components of the device 100 described above may be changed. Also, the device 100 described in the present disclosure may include at least one among the components described above, some of the above components may be omitted, or additional components may be further included in the device 100.

As described above, according to the one or more of the above example embodiments, a memo may be checked in a screen for executing an application selected by a user.

Also, according to the one or more of the above example embodiments, a user may check a memo in a screen for reproducing a content of an application.

In addition, other example embodiments can also be implemented through computer readable code/instructions in/on a medium, e.g., a computer readable medium, to control at least one processing element to implement any above described example embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more example embodiments. The media may also be a distributed network, so that the computer readable code is stored/transferred and executed in a distributed fashion. Furthermore, the processing element could include a processor or a computer processor, and processing elements may be distributed and/or included in a single device.

It should be understood that the example embodiments described therein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from disclosure as defined by the following claims.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A method in an electronic device, comprising:
generating a memo including user information received from a user input;
detecting selection of at least one application to be associated with the generated memo;
in response to the detected selection, displaying an image at least partially overlaying or adjacent to an icon representing the selected at least one application; and
when the selected at least one application is executed, displaying the memo in an execution screen of the at least one application.

2. The method of claim 1, wherein the memo is generated in an execution screen of another executing application.

3. The method of claim 1, further comprising:
detecting selection of a plurality of applications to be associated with the generated memo;
in response to detecting the selection of the plurality of applications, displaying the image at least partially overlaying or adjacent to icons representing the selected plurality of applications; and
when one of the selected plurality of application is executed, displaying the generated memo in an execution screen of the executed one of the selected plurality of applications.

4. The method of claim 1, further comprising:
detecting selection of content included in an application to be associated with the generated memo;
displaying the image corresponding to the generated memo at least partially overlaying or adjacent to a content execution object selectable to display the selected content; and
when the selected content is displayed, displaying the generated memo in an execution screen of the application reproducing the selected content.

5. The method of claim 1, further comprising:
detecting editing the user information of the generated memo displayed in the execution screen of the at least one application, based on the user input; and
displaying the edited user information of the generated memo in the execution screen of the at least one application.

6. The method of claim 1, wherein the detected selection further comprises a drag input signal continuously moving from a first position to a second position on a touch panel of the device.

7. The method of claim 1, wherein the user input is generated by contact of a stylus pen to a touch panel of the device.

8. The method of claim 1, wherein the generated memo is associated with application including a memo function configured to display the generated memo.

9. An electronic device comprising:
a display unit;
an input unit; and
a control unit, configured to:
generate a memo including user information received from a user input detected via the input unit;
detect selection of at least one application be associated with the generated memo;
in response to detecting the selection, controlling the display unit to display an image at least partially overlaying or adjacent to an icon representing the selected at least one application; and
when the selected at least one application is executed, displaying the memo in an execution screen of the at least one application.

10. The device of claim 9, wherein the input unit comprises a touch screen.

11. The device of claim 9, wherein the control unit is further configured to:
detect, via the input unit, a selection of a plurality of applications to be associated with the generated memo, and
in response to detecting the selection of the plurality of applications, displaying the image at least overlaying or adjacent to icons representing the selected plurality of applications, and
when one of the selected plurality of applications is executed, display the generated memo in an execution screen of the executed one of the selected plurality of applications.

12. The device of claim 9, wherein the control unit is further configured to:
detect selection of content included in an application to be associated with the generated memo;
display the image corresponding to the generated memo at least partially overlaying or adjacent to a content execution object selectable to display the selected content; and
when the selected content is displayed, display the generated memo in an execution screen of the application reproducing the selected content.

13. The device of claim 9, wherein the control unit is further configured to:
detect editing the user information of the generated memo displayed in the execution screen of the at least one application, based on the user input; and
display the edited user information of the generated memo in the execution screen of the at least one application.

14. The device of claim 9, wherein the detected selection further comprises a drag input signal continuously moving from a first position to a second position on a touch panel of the device.

15. The device of claim 10, wherein the user input is generated by contact of a stylus pen to the touch screen of the device.

16. The device of claim 9, wherein the generated memo is associated with application including a memo function configured to display the generated memo.

17. A non-transitory computer-readable recording medium of an electronic device having recorded thereon a program, executable by a processor of the electronic device to:
generate a memo including user information received from a user input;
detect selection of at least one application to be associated with the generated memo;
in response to the detected selection, display an image at least partially overlaying or adjacent to an icon representing the selected at least one application; and
when the selected at least one application is executed, display the memo in an execution screen of the at least one application.
